(19) United States
(12) Patent Application Publication
(10) Pub. No.: US 2025/0310878 A1
(43) Pub. Date: Oct. 2, 2025

(54) TECHNIQUES FOR ON-DEMAND USER EQUIPMENT TRANSMISSIONS ON SECONDARY CELLS

(71) Applicant: QUALCOMM Incorporated, San Diego, CA (US)

(72) Inventors: Navid ABEDINI, Basking Ridge, NJ (US); Hung Dinh LY, San Diego, CA (US); Naeem AKL, BRIDGEWATER, NJ (US)

(21) Appl. No.: 18/625,016

(22) Filed: Apr. 2, 2024

(51) Int. Cl. H04W 52/02

(52) U.S. Cl. CPC H04W 52/0229; H04W 52/0212

(57) ABSTRACT

Methods, systems, and devices for wireless communications are described that provide for uplink wake-up signal (WUS) transmissions from a user equipment (UE) that may provide information to a network entity that may facilitate efficient decisions by the network entity, such as efficient synchronization signal block (SSB) activation of a secondary cell (SCell). The network entity provide a WUS configuration to a UE that indicates a set of WUS occasions for transmission of a WUS associated with a SCell. The UE, upon receipt of an indication to transmit a WUS using one or more WUS occasions, may transmit a WUS that may be used by one or more network entities for one or more operational decisions for communications with the UE.

### FIELD OF TECHNOLOGY

The following relates to wireless communications, including techniques for on-demand user equipment transmissions on secondary cells.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for on-demand user equipment (UE) transmissions on secondary cells. For example, the described techniques provide for uplink wake-up signal (WUS) transmissions from a UE that may provide information to a network entity that may facilitate efficient decisions by the network entity (e.g., efficient synchronization signal block (SSB) activation of a secondary cell (SCell)). In some aspects, a network entity provide a WUS configuration to a UE that indicates a set of WUS occasions for transmission of a WUS associated with a SCell. In some cases the UE, upon receipt of an indication to transmit a WUS using one or more WUS occasions, may transmit a WUS that may be used by one or more network entities for one or more operational decisions for communications with the UE. For example, a network entity associated with a SCell may receive the WUS from the UE and, based on a signal strength of the received WUS, select a beam and/or transmission-reception point (TRP) for further communications with the UE.

A method for wireless communications by a user equipment (UE) is described. The method may include receiving a WUS configuration including a set of multiple WUS occasions for transmission of a WUS associated with a second cell, receiving, from a first cell, an indication to transmit the WUS using at least a first WUS occasion of the set of multiple WUS occasions, where the WUS provides information associated with the second cell, and transmitting at least a first WUS in the first WUS occasion based on the indication.

A UE for wireless communications is described. The UE may include one or more memories storing processor executable code, and one or more processors coupled with the one or more memories. The one or more processors may individually or collectively be operable to execute the code to cause the UE to receive a WUS configuration including a set of multiple WUS occasions for transmission of a WUS associated with a second cell, receive, from a first cell, an indication to transmit the WUS using at least a first WUS occasion of the set of multiple WUS occasions, where the WUS provides information associated with the second cell, and transmit at least a first WUS in the first WUS occasion based on the indication.

Another UE for wireless communications is described. The UE may include means for receiving a WUS configuration including a set of multiple WUS occasions for transmission of a WUS associated with a second cell, means for receiving, from a first cell, an indication to transmit the WUS using at least a first WUS occasion of the set of multiple WUS occasions, where the WUS provides information associated with the second cell, and means for transmitting at least a first WUS in the first WUS occasion based on the indication.

A non-transitory computer-readable medium storing code for wireless communications is described. The code may include instructions executable by one or more processors to receive a WUS configuration including a set of multiple WUS occasions for transmission of a WUS associated with a second cell, receive, from a first cell, an indication to transmit the WUS using at least a first WUS occasion of the set of multiple WUS occasions, where the WUS provides information associated with the second cell, and transmit at least a first WUS in the first WUS occasion based on the indication.

In some examples of the method, UEs, and non-transitory computer-readable medium described herein, the receiving the indication to transmit the WUS may include operations, features, means, or instructions for receiving an indication that a set of multiple WUSs are to be transmitted at periodic intervals, and where the transmitting includes transmitting the set of multiple WUSs at the periodic intervals.

In some examples of the method, UEs, and non-transitory computer-readable medium described herein, the receiving the indication to transmit the WUS may include operations, features, means, or instructions for receiving an indication that the second cell is to be transitioned from an inactive state to an active state.

In some examples of the method, UEs, and non-transitory computer-readable medium described herein, the indication to transmit the WUS provides an explicit indication or an implicit indication that the WUS is to be transmitted, and where the indication to transmit the WUS may be provided in a message that activates the second cell or may be provided in a second message that is separate from the message that activates the second cell.

In some examples of the method, UEs, and non-transitory computer-readable medium described herein, the indication to transmit the WUS indicates that one or more of the set of multiple WUS occasions are to be used to indicate one or more beams detected at the UE, and where the one or more beams correspond to beams having a highest measurement value, beams having measurement values that exceed a threshold value, or any combination thereof.

In some examples of the method, UEs, and non-transitory computer-readable medium described herein, the indication to transmit the WUS indicates that the WUS is to be transmitted based on a prediction at the UE associated with the first WUS. In some examples of the method, UEs, and non-transitory computer-readable medium described herein, the prediction at the UE is based on a machine learning algorithm output value that satisfies one or more conditions that indicate that the first WUS is to be transmitted.

In some examples of the method, UEs, and non-transitory computer-readable medium described herein, the indication to transmit the WUS indicates whether one or more on-demand synchronization signal blocks (SSBs) will be activated subsequent to first WUS. In some examples of the method, UEs, and non-transitory computer-readable medium described herein, the indication of whether the one or more on-demand SSBs are activated is indicated dynamically or semi statically for one or more cells.

In some examples of the method, UEs, and non-transitory computer-readable medium described herein, transmitting at least the first WUS may include operations, features, means, or instructions for transmitting the first WUS to the first cell. In some examples of the method, UEs, and non-transitory computer-readable medium described herein, the first WUS includes a random access channel transmission, an uplink control channel transmission, or an uplink shared channel transmission. In some examples of the method, UEs, and non-transitory computer-readable medium described herein, the first WUS includes a random access channel transmission having a preamble identification that indicates one or more of a detected secondary cell, one or more detected beams associated with the detected secondary cell, or any combination thereof.

A method for wireless communications by a network entity is described. The method may include outputting a WUS configuration to a UE that provides a set of multiple WUS occasions for transmission of a WUS associated with a second cell and outputting, to the UE via a first cell, an indication to transmit the WUS using at least a first WUS occasion of the set of multiple WUS occasions, where the WUS provides information associated with the second cell, and where a first WUS is to be transmitted in the first WUS occasion based on the second signal.

A network entity for wireless communications is described. The network entity may include one or more memories storing processor executable code, and one or more processors coupled with the one or more memories. The one or more processors may individually or collectively be operable to execute the code to cause the network entity to output a WUS configuration to a UE that provides a set of multiple WUS occasions for transmission of a WUS associated with a second cell and output, to the UE via a first cell, an indication to transmit the WUS using at least a first WUS occasion of the set of multiple WUS occasions, where the WUS provides information associated with the second cell, and where a first WUS is to be transmitted in the first WUS occasion based on the second signal.

Another network entity for wireless communications is described. The network entity may include means for outputting a WUS configuration to a UE that provides a set of multiple WUS occasions for transmission of a WUS associated with a second cell and means for outputting, to the UE via a first cell, an indication to transmit the WUS using at least a first WUS occasion of the set of multiple WUS occasions, where the WUS provides information associated with the second cell, and where a first WUS is to be transmitted in the first WUS occasion based on the second signal.

A non-transitory computer-readable medium storing code for wireless communications is described. The code may include instructions executable by one or more processors to output a WUS configuration to a UE that provides a set of multiple WUS occasions for transmission of a WUS associated with a second cell and output, to the UE via a first cell, an indication to transmit the WUS using at least a first WUS occasion of the set of multiple WUS occasions, where the WUS provides information associated with the second cell, and where a first WUS is to be transmitted in the first WUS occasion based on the second signal.

In some examples of the method, network entities, and non-transitory computer-readable medium described herein, the outputting the indication to transmit the WUS may include operations, features, means, or instructions for outputting, to the UE via a first cell, an indication that a set of multiple WUSs are to be transmitted at periodic intervals.

In some examples of the method, network entities, and non-transitory computer-readable medium described herein, the outputting the indication to transmit the WUS may include operations, features, means, or instructions for outputting an indication that the second cell is to be transitioned from an inactive state to an active state.

In some examples of the method, network entities, and non-transitory computer-readable medium described herein, the indication to transmit the WUS provides an explicit indication or an implicit indication that the WUS is to be transmitted from the UE, and where the second signal may be provided in a message that activates the second cell or may be provided in a second message that is separate from the message that activates the second cell.

In some examples of the method, network entities, and non-transitory computer-readable medium described herein, the indication to transmit the WUS indicates that one or more of the set of multiple WUS occasions are to be used to indicate one or more beams detected at the UE, and where the one or more beams correspond to beams having a highest measurement value, beams having measurement values that exceed a threshold value, or any combination thereof.

In some examples of the method, network entities, and non-transitory computer-readable medium described herein, the indication to transmit the WUS indicates that the WUS is to be transmitted based on a prediction at the UE associated with the first WUS. In some examples of the method, network entities, and non-transitory computer-readable medium described herein, the prediction at the UE is based on a machine learning algorithm output value that satisfies one or more conditions that indicate that the first WUS is to be transmitted.

In some examples of the method, network entities, and non-transitory computer-readable medium described herein, the indication to transmit the WUS indicates whether one or more on-demand SSBs will be activated subsequent to first WUS. In some examples of the method, network entities, and non-transitory computer-readable medium described herein, the indication of whether the one or more on-demand SSBs are activated is indicated dynamically or semi statically for one or more cells.

Some examples of the method, network entities, and non-transitory computer-readable medium described herein may further include operations, features, means, or instructions for obtaining the first WUS via the first cell. In some examples of the method, network entities, and non-transitory computer-readable medium described herein, the first WUS includes a random access channel transmission, an uplink control channel transmission, or an uplink shared channel transmission. In some examples of the method, network entities, and non-transitory computer-readable medium described herein, the first WUS includes a random access channel transmission having a preamble identification that indicates one or more of a detected secondary cell, one or more detected beams associated with the detected secondary cell, or any combination thereof.

### BRIEF DESCRIPTION OF THE DRAWINGS

FIG. 1 shows an example of a wireless communications system that supports techniques for on-demand user equipment (UE) transmissions on secondary cells in accordance with one or more aspects of the present disclosure.

FIG. 2 shows an example of a wireless communications system that supports techniques for on-demand UE transmissions on secondary cells in accordance with one or more aspects of the present disclosure.

FIG. 3 shows an example of an on-demand synchronization signal block transmission pattern that supports techniques for on-demand UE transmissions on secondary cells in accordance with one or more aspects of the present disclosure.

FIG. 4 shows an example of a process flow that supports techniques for on-demand UE transmissions on secondary cells in accordance with one or more aspects of the present disclosure.

FIGS. 5 and 6 show block diagrams of devices that support techniques for on-demand UE transmissions on secondary cells in accordance with one or more aspects of the present disclosure.

FIG. 7 shows a block diagram of a communications manager that supports techniques for on-demand UE transmissions on secondary cells in accordance with one or more aspects of the present disclosure.

FIG. 8 shows a diagram of a system including a device that supports techniques for on-demand UE transmissions on secondary cells in accordance with one or more aspects of the present disclosure.

FIGS. 9 and 10 show block diagrams of devices that support techniques for on-demand UE transmissions on secondary cells in accordance with one or more aspects of the present disclosure.

FIG. 11 shows a block diagram of a communications manager that supports techniques for on-demand UE transmissions on secondary cells in accordance with one or more aspects of the present disclosure.

FIG. 12 shows a diagram of a system including a device that supports techniques for on-demand UE transmissions on secondary cells in accordance with one or more aspects of the present disclosure.

FIGS. 13 and 14 show flowcharts illustrating methods that support techniques for on-demand UE transmissions on secondary cells in accordance with one or more aspects of the present disclosure.

### DETAILED DESCRIPTION

In some wireless communication systems, SSBs may be periodically transmitted in different directions using different directional beams by network entities for measurement and selection by a user equipment (UE) for further communications between the UE and network. In some deployments, a relatively large quantity of SSBs may be transmitted in accordance with a beam configuration with a corresponding relatively large quantity of beams (e.g., 64 beams). In cases where such SSBs are transmitted periodically (e.g., according to a 20 ms periodicity), these transmissions may consume a relatively large amount of power. In order to reduce the amount of power consumed by network entities in such deployments, network energy savings (NES) techniques have been proposed that may allow a network entity to transmit a reduced quantity of SSBs, and thus reduce power consumption. For example, a secondary cell (SCell) may be configured to transmit some or all SSBs for certain time periods upon receipt of a trigger to transmit SSBs, such as a wake-up signal (WUS) that may be transmitted by a UE. However, in some cases the network may determine that an SCell should be activated, such as when a traffic load is increasing beyond a capacity of other activated cells. In such cases, it may be beneficial for the network to have information related to a configuration of the SCell that would provide for efficient communications.

In accordance with various aspects a network entity may trigger one or more UEs to transmit one or more WUSs to one or more cells, which may be measured for use in configuration of the one or more cells. In some aspects, a network entity provide a WUS configuration to a UE that indicates a set of WUS occasions for transmission of one or more WUSs associated with one or more cells (e.g., an SCell). In some cases, the UE, upon receipt of an indication to transmit a WUS using one or more WUS occasions, may transmit the one or more WUSs. A network entity may receive the one or more WUSs and make one or more operational decisions for communications with the UE. For example, a network entity associated with a SCell may receive the WUS from the UE and, based on a signal strength of the received WUS, select a beam and/or transmission-reception point (TRP) for further communications with the UE. Such techniques may allow for efficient network operation through measurement of WUS transmissions of one or more UEs, while also providing for reduced power consumption by network entities.

Aspects of the disclosure are initially described in the context of wireless communications systems. Aspects of the disclosure are further illustrated by and described with reference to SSB patterns, process flows, apparatus diagrams, system diagrams, and flowcharts that relate to techniques for on-demand UE transmissions on secondary cells.

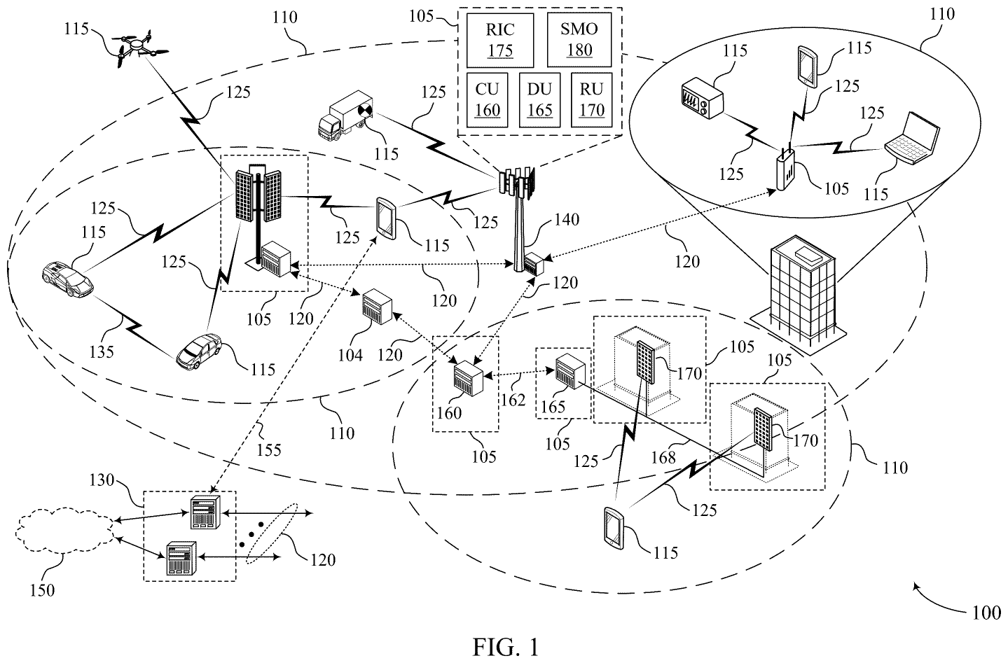

FIG. 1 shows an example of a wireless communications system 100 that supports techniques for on-demand UE transmissions on secondary cells in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless

communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ns may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many 1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)) which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some aspects a network entity 105 may trigger one or more UEs 115 to transmit one or more WUSs to one or more cells, which may be measured for use in configuration of the one or more cells. In some cases, a network entity 105 provide a WUS configuration to a UE 115 that indicates a set of WUS occasions for transmission of one or more WUSs associated with one or more cells (e.g., an SCell). In some cases, the UE 115, upon receipt of an indication to transmit a WUS using one or more WUS occasions, may transmit the one or more WUSs. A network entity 105 may receive the one or more WUSs and make one or more operational decisions for communications with the UE 115. For example, a network entity associated with a SCell may receive the

WUS from the UE 115 and, based on a signal strength of the received WUS, select a beam and/or transmission-reception point (TRP) for further communications with the UE 115.

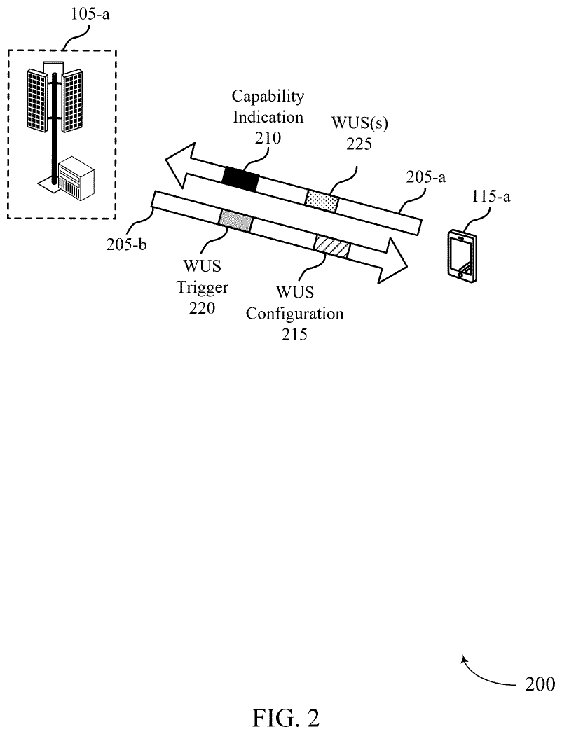

FIG. 2 shows an example of a wireless communications system 200 that supports techniques for on-demand UE transmissions on secondary cells in accordance with one or more aspects of the present disclosure. The wireless communications system 200 may be an example of a wireless communications system 100 as described with reference to FIG. 1. The wireless communications system 200 may include a UE 115-a, which may be an example of a UE 115 as described with reference to FIG. 1, and a network entity 105-a, which may be an example of a network entity 105, a CU, a DU, an RU, or any combination thereof, as described with reference to FIG. 1. The UE 115-a and network entity 105-a may communicate via one or more access links 205 that may include an uplink channel 205-a and a downlink channel 205-b. Additionally, or alternatively, the wireless communications system 200 may include multiple network entities 105 supporting different network functionality. For example, separate network entities 105 may provide different cells, where one or multiple cells may include multiple TRPs. The wireless communications system 200 may support signaling for establishing WUS configurations and triggering WUS transmissions.

In some aspects, such as illustrated in the example of FIG. 2, the UE 115-a may transmit a capability indication 210 that indicates a capability of the UE 115-a to perform WUS transmissions. In some aspects, the capability indication may be provided in radio resource control (RRC) information, in a medium access control (MAC) control element (CE), in response to a capability query from the network entity 105-a, or any combination thereof. In some aspects, the network entity 105-a may determine to implement one or more NES techniques, and may transmit a WUS configuration 215 to the UE 115-a. In some cases, the WUS configuration 215 may configure a set of resources that are available for transmission of an uplink WUS 225, which may be referred to as WUS occasions. For example, a WUS occasion may include time and frequency resources that are to be used by the UE 115-b to transmit uplink WUS 225. Further, in some examples, different WUS occasions may be associated with different SSBs or beams, and the UE 115-b may select one or more WUS occasions for transmission of one or more WUSs 225 based on measured SSB parameters (e.g., N WUS occasions associated with N SSBs having the highest measured reference signal received power (RSRP)). In some cases, the WUS configuration 215 may provide that the UE 115-a is to transmit one or more WUSs 225 upon receipt of a WUS trigger 220. The WUS configuration 215 may be provided, for example, in RRC signaling, in configuration information that configures one or more SCells, or other control channel of shared channel communications).

For example, the WUS configuration 215 may indicate that on-demand SSBs are configured on an SCell in accordance with a NES configuration of the SCell. While operating in the NES mode, the SCell prior to its activation (or active communications with the UE 115-a) may send its SSBs with a different configuration compared to an active or non-NES configuration. For example, such an SCell may transmit no SSBs, may transmit infrequent SSBs (e.g., every 160 msec instead of every 20 msec), may transmit a ‘light-SSB’ or discovery reference signal (e.g., a primary synchronization signal (PSS) only, or SSB without a physical broadcast channel (PBCH)). additionally, or alternatively, such an SCell may transmit SSBs with different beamforming configurations (e.g., in terms of a quantity of beams, beam-width, or both). In some cases, while operating in the NES mode, the SCell may transmit one or more SSBs in response to a WUS 225. Additionally, or alternatively, on-demand SSBs may be transmitted based on a network trigger (e.g., a trigger from a PCell). In some aspects, the WUS configuration 215 and WUSs 225 may be associated with a SCell, and the UE 115-a may be in a connected mode with the network via a PCell, and thus the network may be aware of various conditions of the UE 115-a (e.g., its measurements of available downlink reference signals on the SCell or other cells, traffic demand, etc.), and the network may use this information to determine that on-demand SSB transmissions of an SCell should be activated. In various aspects discussed herein, one or more WUS 225 transmissions from the UE 115-a may provide information to the network that may facilitate a more efficient SSB activation decision.

In some aspects, a PCell, triggered by a determination to activate an SCell, may schedule the UE 115-a to send one or more WUS 225 transmissions to one or multiple configured SCells. In some cases, the scheduling of the UE 115-a to transmit the one or more WUSs 225 may be dynamic (e.g., in a downlink control information (DCI) communication to the UE 115-a) or semi-static (e.g., via configuration information provided to the UE 115-a). In some cases, scheduling the UE 115-a to transmit the one or more on-demand WUS 225 transmissions may be done in conjunction with SCell activation (e.g., explicitly or implicitly indicated along with SCell activation in a same communication such as a MAC-CE and/or associated physical downlink control channel (PDCCH) transmission that activates the SCell). In some cases, the UE 115-a may be indicated (e.g., semi-statically and/or dynamically using the described signaling) how to select one or more WUS occasions for sending the one or more uplink WUS 225 transmissions. In some cases, the indication of how to select the WUS occasions may be provided the WUS configuration 215 (e.g., semi-statically), or in the WUS trigger 220 (e.g., dynamically), or both. For example, the UE 115-a may be indicated with a quantity of WUS occasions on which to transmit (e.g., a maximum quantity of occasions), whether the WUS occasions are to correspond to the strongest beams (e.g., N WUS occasions associated with the N strongest beams), whether to transmit a WUS associated with any beams beyond a configured threshold, or any combination thereof.

In some aspects, the UE 115-a may determine to send one or more WUS 225 transmissions based on one or more prediction-based triggering conditions. For example, an output of a machine learning (ML) based prediction algorithm may be used along with some configured conditions (e.g., in terms of thresholds on an output value or whether the output value belongs to a specified set of values) for the UE 115-a to decide whether it should send a WUS 225, to which SCell(s) to transmit a WUS 225, on which WUS occasion(s), with which configuration (e.g., in terms of preamble ID, power configuration, etc.), or any combination thereof.

In some aspects, additionally, or alternatively, the WUS configuration 215, WUS trigger 220, or both, may indicate whether the UE 115-a may assume on-demand SSBs will be activated after sending the uplink WUS 225 or not. Further, if SSBs are to be activated in response to the WUS 225 transmission, the network may indicate a configuration of the SSB transmission (e.g., in terms of offsets, locations, periodicities, number of beams, etc.). In some cases, the indication may be dynamic (e.g., provided in a DCI with the WUS trigger 220) and/or semi static (e.g., provided with the WUS configuration 215). Further, the indication for the configuration of the on-demand SSBs may be cell-specific (e.g., different configurations for different SCells). In some cases, additionally, or alternatively, the UE 115-a may send an uplink WUS 225 transmission to a PCell, rather than an SCell. In this case, the uplink WUS 225 transmission may be in the form of a physical random access channel (PRACH) transmission, a physical uplink control channel (PUCCH) transmission, a physical uplink shared channel (PUSCH) transmission, or any combination thereof. In aspects that use a PRACH transmission, a preamble ID may be used to indicate carry the info (e.g., detected SCells, strongest detected SCells, and/or beams of the SCells). In some aspects, the network entity 105-a, upon receipt of the uplink WUS 225 transmission, may determine one or more aspects of further communications, such as a beam or beams to activate on the SCell, and/or one or more TRPs associated with the SCell to activate.

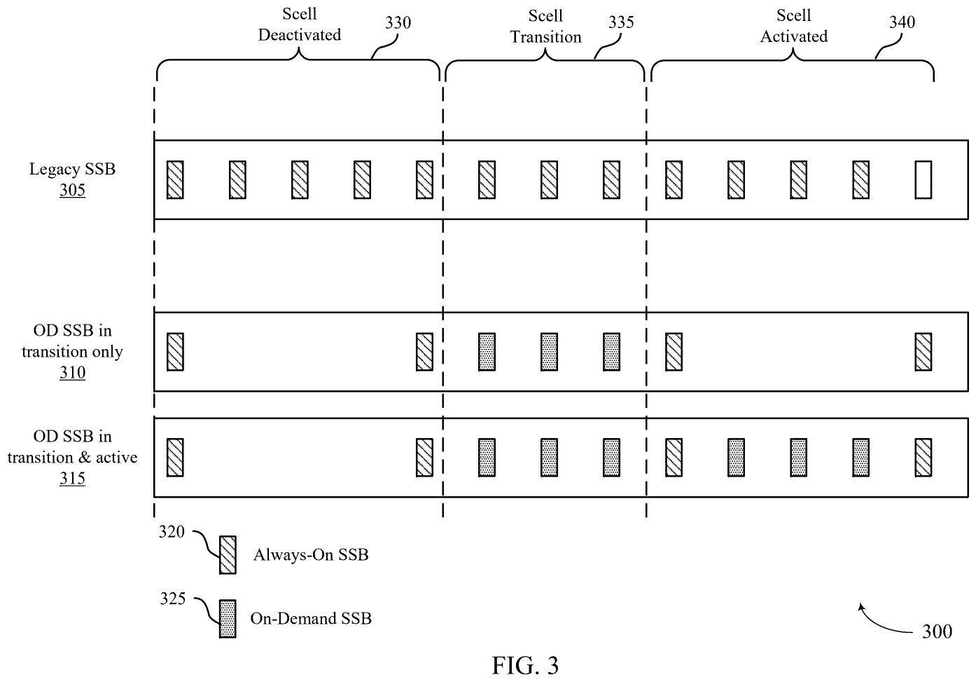

FIG. 3 shows an example of an on-demand SSB transmission pattern 300 that supports techniques for on-demand UE transmissions on secondary cells in accordance with one or more aspects of the present disclosure. In some cases, aspects of the on-demand SSB transmission pattern 300 may implement or be implemented by aspects of a wireless communications system 100 or 200, as described with reference to FIGS. 1 and 2. For example, the on-demand SSB transmission pattern 300 may be configured at a SCell and a UE 115, which may be examples of a network entity 105 and UE 115 as described with reference to FIGS. 1 and 2.

In this example, an SCell may be configured to transmit always-on SSBs 320 and may transmit on-demand SSBs 325 in response to a WUS. For example, in cases where the SCell is configured in a non-NES mode, a legacy SSB pattern 305 may include always-on SSBs 320 transmitted at a relatively short periodicity (e.g., every 20 msec). When in a NES mode, the SCell may transmit always-on SSBs 320 with a longer periodicity (e.g., every 80 ms) during a deactivated state 330, and upon receipt of a WUS may change to a transition pattern 310 in which on-demand SSBs 325 may be transmitted with a shorter periodicity (e.g., 20 msec) during an SCell transition state 335. In some cases, during an SCell activated state 340, the SCell may transmit only the always-on SSBs 320. In other cases, a WUS may cause the SCell to change to a transition and active pattern 315 in which on-demand SSBs 325 may be transmitted with a shorter periodicity (e.g., 20 msec between each always-on SSB 320) during both the SCell transition state 335 and the SCell activated state 340.

In such examples, the UE may perform measurements using the relatively infrequent always-on SSBs 320 when the SCell is operating in an NES mode, but more frequent SSBs might be desirable prior/during SCell activation, such as for refining time and frequency synchronization, performing beam selection, performing automatic gain control (AGC) procedures, and the like. Additionally, in multi-beam operation (e.g., when the SCell supports many beams, such as up to 64 beams), it may be desired to activate frequent transmissions of SSBs for only one or more relevant beams for a UE, and not all the beams. In such examples, an on-demand WUS from the UE may provide the network with information on which beams are relevant beams to the UE. In some examples, prior to SCell activation, the UE may perform layer 3 (L3) measurements and provide associated reports. However, such L3 measurement reports may be provided to a CU instead of DU, such that the DU is not aware of this measurement while the DU is the network entity that makes decisions related to transmission on on-demand SSBs 325. Moreover, L3 measurements and reports are relatively slow. Using techniques for WUS transmissions from a UE as discussed herein may thus provide for an effective layer 1 (L1) report, which is faster, local, and goes to the DU for determination of SSB activation.

In some other aspects, a cell (e.g., a SCell that is operating in a NES mode) may have multiple TRPs (e.g., TRPs that are distributed across a coverage area) that each may transmit SSBs on overlapping time and frequency resources, using multiple transmit/receive chains, where one SSB may be transmitted in multiple beam directions (e.g., using digital beamforming). Measurements at a UE of such SSBs may not be able to differentiate between TRPs or digital beams. Further, from a NES perspective, the network may desire to only activate and use relevant TRPs and/or beams. This can be done at a later stage, such as by configuring multiple reference signals (e.g., channel state information (CSI) reference signals), and associated measurements and reports, but such techniques may result in a relatively large latency along with relatively high network and UE power consumption. Using on-demand uplink WUS transmissions as discussed herein may allow one or more WUSs to be sent by the UE and to be monitored by multiple TRPs or digital receive chains, which may allow the network to efficiently identify the relevant TRP or digital beam for further communications (e.g., for sending on-demand SSBs).

In further aspects, a UE may be performing a beam prediction algorithm (e.g., a ML-based prediction) such that, based on relatively infrequent downlink measurements (e.g., in the time and/or spatial domain), the UE may predict or infer a quality of beams in future time periods or in other spatial directions. Such beams may be specifically associated with an SCell operating in a NES mode. In such cases, an uplink on-demand WUS may allow for a relatively fast, local, lower-layer report of a result of UE's prediction (e.g., by transmitting one or more WUSs using one or more WUS occasions associated with SSBs or beams that have highest predicted channel properties). It is noted that the various examples discussed herein for transmission of on-demand WUSs by a UE are provided for discussion and illustration, and uplink WUS transmissions as discussed herein may have various other uses in addition to, or alternatively to, the discussed examples.

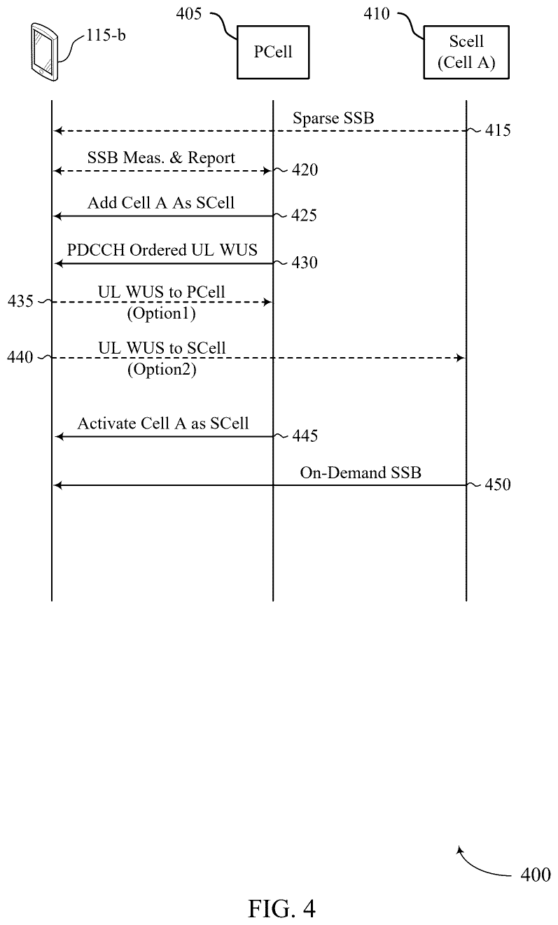

FIG. 4 shows an example of a process flow 400 that supports techniques for on-demand UE transmissions on secondary cells in accordance with one or more aspects of the present disclosure. In some cases, aspects of the process flow 400 may implement or be implemented by aspects of a wireless communications system 100 or 200, or an on-demand SSB transmission pattern 300, as described with reference to FIGS. 1 through 3. For example, the process flow 400 may include a UE 115-b, which may be an example of a UE 115 as described with reference to FIGS. 1 through 3. Additionally, the process flow 400 may include a PCell 405 and an SCell 410, which may be examples of a network entity 105, a CU, a DU, an RU, or any combination thereof as described with reference to FIGS. 1 through 3.

In the following description of the process flow 400, the operations may be performed in a different order than the order shown. Additionally, or alternatively, other operations may be added or removed from the process flow 400. Although the UE 115-b, the PCell 405, and the SCell 410 are shown performing the operations of the process flow 400, some aspects of some operations may be performed by one or more other devices (e.g., other UEs 115, other network entities 105, or other entities external to the network, such as non-integrated entities).

At 415, the SCell 410 may be operating in a NES mode, and may transmit sparse SSBs. For example, the SCell 410 may transmit SSBs at an 80 msec periodicity, which provides less frequent SSBs than in cases where the SCell 410 may be operating in a non-NES mode and transmit SSBs at a 20 msec periodicity. In some cases, a WUS configuration may be provided to the UE 115-b that indicates SSB periodicities of one or more cells when operating in an NES mode.

At 420, the UE 115-b may perform SSB measurements and provide a report that may be received at the PCell 405. In some cases, the SSB measurements may be based on the sparse SSBs transmitted by the SCell 410. At 425, the PCell 405 may determine to configure the SCell 410 at the UE 115-b, and may transmit an indication to the UE 115-b to add SCell 410. In some cases, the configuration of the SCell 410 at the UE 115-b may include a WUS configuration that indicates one or more WUS occasions (e.g., time/frequency resources available for an uplink WUS transmission), and that the UE 115-b may be triggered to transmit one or more WUSs using one or more of the configured WUS occasions.

At 430, the PCell 405 may provide a WUS trigger to the UE 115-b, such as a PDCCH ordered uplink WUS. For example, a DCI may be provided via PDCCH that indicates that the UE 115-b is to transmit one or more WUSs to the SCell 410. In some examples, at 435, the UE 115-b may transmit an uplink WUS to the PCell 405. In such examples, such a WUS may be transmitted via PRACH (e.g., using a preamble ID that indicates one or more preferred beams or SSBs of the SCell 410), PUCCH (e.g., using uplink control information that indicates one or more preferred beams or SSBs of the SCell 410), or PUSCH (e.g., using a MAC-CE that indicates one or more preferred beams or SSBs of the SCell 410). In other examples, at 440, the UE 115-b may transmit an uplink WUS to the PCell 405. In such examples, such a WUS may be transmitted using one or more WUS occasions, where each WUS occasion is associated with a particular SSB or beam and may indicate that the corresponding SSB or beam has more favorable channel conditions as measured at the UE 115-b.

At 445, the PCell 405 may activate SCell 410, and transmit an activation signal that may be received as the UE 115-b. At 450, the SCell 410 may transmit one or more on-demand SSBs. The one or more on-demand SSBs may be measured at the UE 115-b for selecti n of a beam for further communications between the UE 115-b and SCell 410, and the UE 115-b and SCell 410 may establish a connection in accordance with connection establishment techniques.

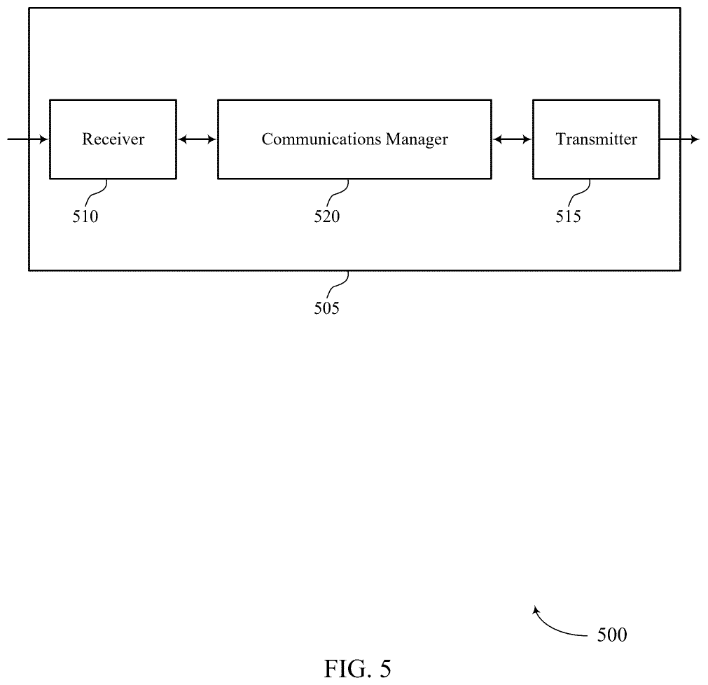

FIG. 5 shows a block diagram 500 of a device 505 that supports techniques for on-demand UE transmissions on secondary cells in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for on-demand UE transmissions on secondary cells). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for on-demand UE transmissions on secondary cells). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for on-demand UE transmissions on secondary cells as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a WUS configuration including a set of multiple WUS occasions for transmission of a WUS associated with a second cell. The communications manager 520 is capable of, configured to, or operable to support a means for receiving, from a first cell, an indication to transmit the WUS using at least a first WUS occasion of the set of multiple WUS occasions, where the WUS provides information associated with the second cell. The communications manager 520 is capable of, configured to, or operable to support a means for transmitting at least a first WUS in the first WUS occasion based on the indication.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques that allow for efficient network operation through measurement of one or more on-demand WUS transmissions of one or more UEs, while also providing for reduced power consumption by network entities.

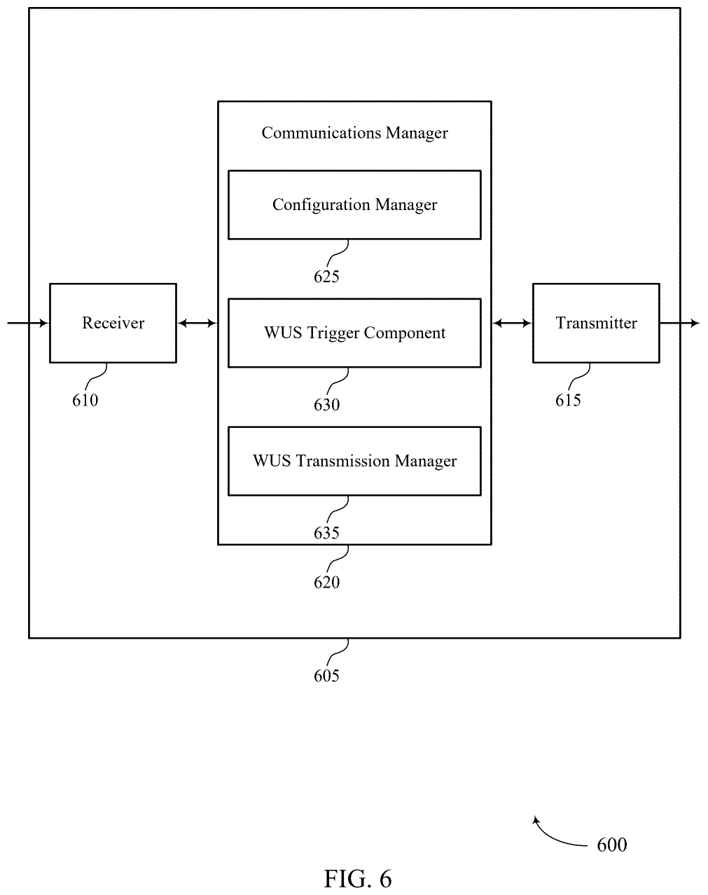

FIG. 6 shows a block diagram 600 of a device 605 that supports techniques for on-demand UE transmissions on secondary cells in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for on-demand UE transmissions on secondary cells). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for on-demand UE transmissions on secondary cells). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for on-demand UE transmissions on secondary cells as described herein. For example, the communications manager 620 may include a configuration manager 625, a WUS trigger component 630, a WUS transmission manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The configuration manager 625 is capable of, configured to, or operable to support a means for receiving a WUS configuration including a set of multiple WUS occasions for transmission of a WUS associated with a second cell. The WUS trigger component 630 is capable of, configured to, or operable to support a means for receiving, from a first cell, an indication to transmit the WUS using at least a first WUS occasion of the set of multiple WUS occasions, where the WUS provides information associated with the second cell. The WUS transmission manager 635 is capable of, configured to, or operable to support a means for transmitting at least a first WUS in the first WUS occasion based on the indication.

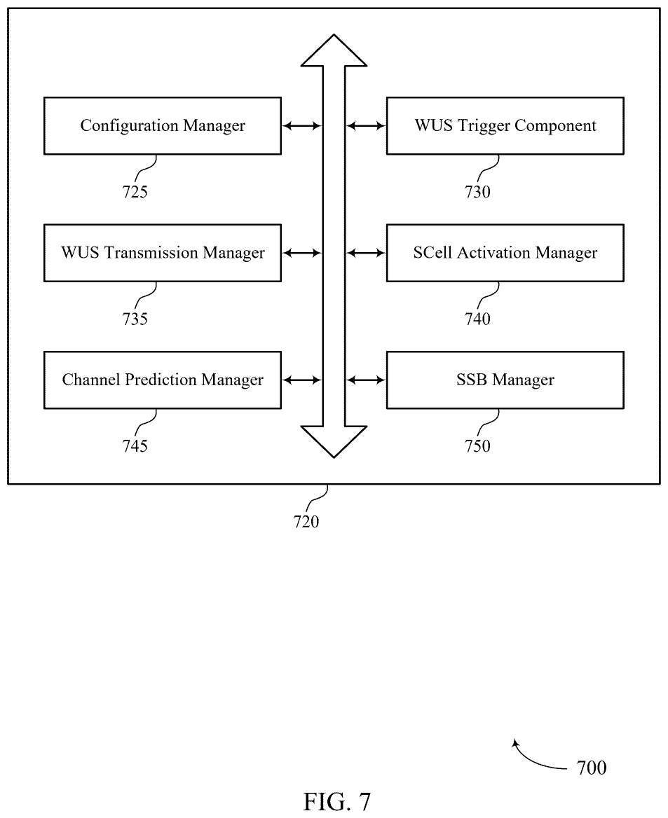

FIG. 7 shows a block diagram 700 of a communications manager 720 that supports techniques for on-demand UE transmissions on secondary cells in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for on-demand UE transmissions on secondary cells as described herein. For example, the communications manager 720 may include a configuration manager 725, a WUS trigger component 730, a WUS transmission manager 735, a SCell activation manager 740, a channel prediction manager 745, an SSB manager 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The configuration manager 725 is capable of, configured to, or operable to support a means for receiving a WUS configuration including a set of multiple WUS occasions for transmission of a WUS associated with a second cell. The WUS trigger component 730 is capable of, configured to, or operable to support a means for receiving, from a first cell, an indication to transmit the WUS using at least a first WUS occasion of the set of multiple WUS occasions, where the WUS provides information associated with the second cell. The WUS transmission manager 735 is capable of, configured to, or operable to support a means for transmitting at least a first WUS in the first WUS occasion based on the indication.

In some examples, to support receiving the indication to transmit the WUS, the WUS trigger component 730 is capable of, configured to, or operable to support a means for receiving an indication that a set of multiple WUSs are to be transmitted at periodic intervals, and where the transmitting includes transmitting the set of multiple WUSs at the periodic intervals. In some examples, to support receiving the indication to transmit the WUS, the WUS trigger component 730 is capable of, configured to, or operable to support a means for receiving an indication that the second cell is to be transitioned from an inactive state to an active state. In some examples, the indication to transmit the WUS provides an explicit indication or an implicit indication that the WUS is to be transmitted, and where the indication to transmit the WUS is provided in a message that activates the second cell or is provided in a second message that is separate from the message that activates the second cell.

In some examples, the indication to transmit the WUS indicates that one or more of the set of multiple WUS occasions are to be used to indicate one or more beams detected at the UE, and where the one or more beams correspond to beams having a highest measurement value, beams having measurement values that exceed a threshold value, or any combination thereof. In some examples, the indication to transmit the WUS indicates that the WUS is to be transmitted based on a prediction at the UE associated with the first WUS. In some examples, the prediction at the UE is based on a machine learning algorithm output value that satisfies one or more conditions that indicate that the first WUS is to be transmitted. In some examples, the indication to transmit the WUS indicates whether one or more on-demand SSBs will be activated subsequent to first WUS. In some examples, the indication of whether the one or more on-demand SSBs are activated is indicated dynamically or semi statically for one or more cells.

In some examples, to support transmitting at least the first WUS, the WUS transmission manager 735 is capable of, configured to, or operable to support a means for transmitting the first WUS to the first cell. In some examples, the first WUS includes a random access channel transmission, an uplink control channel transmission, or an uplink shared channel transmission. In some examples, the first WUS includes a random access channel transmission having a preamble identification that indicates one or more of a detected secondary cell, one or more detected beams associated with the detected secondary cell, or any combination thereof.

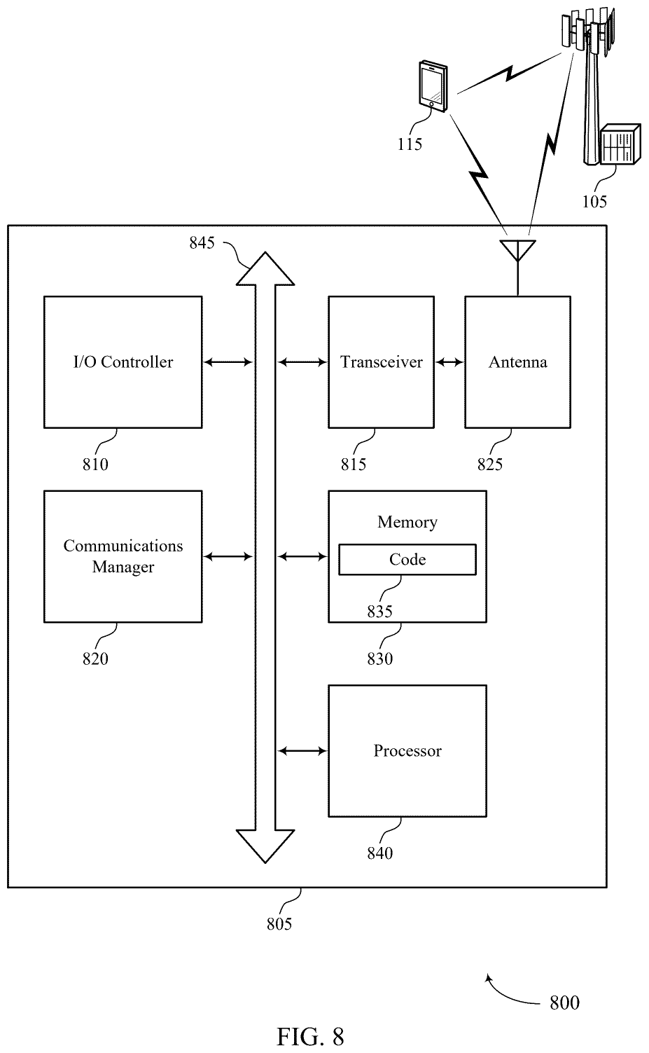

FIG. 8 shows a diagram of a system 800 including a device 805 that supports techniques for on-demand UE transmissions on secondary cells in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for on-demand UE transmissions on secondary cells). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a WUS configuration including a set of multiple WUS occasions for transmission of a WUS associated with a second cell. The communications manager 820 is capable of, configured to, or operable to support a means for receiving, from a first cell, an indication to transmit the WUS using at least a first WUS occasion of the set of multiple WUS occasions, where the WUS provides information associated with the second cell. The communications manager 820 is capable of, configured to, or operable to support a means for transmitting at least a first WUS in the first WUS occasion based on the indication.

By including or configuring the communications manager 820 in accordance with examples as described herein, the device 805 may support techniques for that allow for efficient network operation through measurement of one or more on-demand WUS transmissions of one or more UEs, while also providing for reduced power consumption by network entities.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for on-demand UE transmissions on secondary cells as described herein, or the at least one processor 840 and the at least one memory 830 may be otherwise configured to, individually or collectively, perform or support such operations.

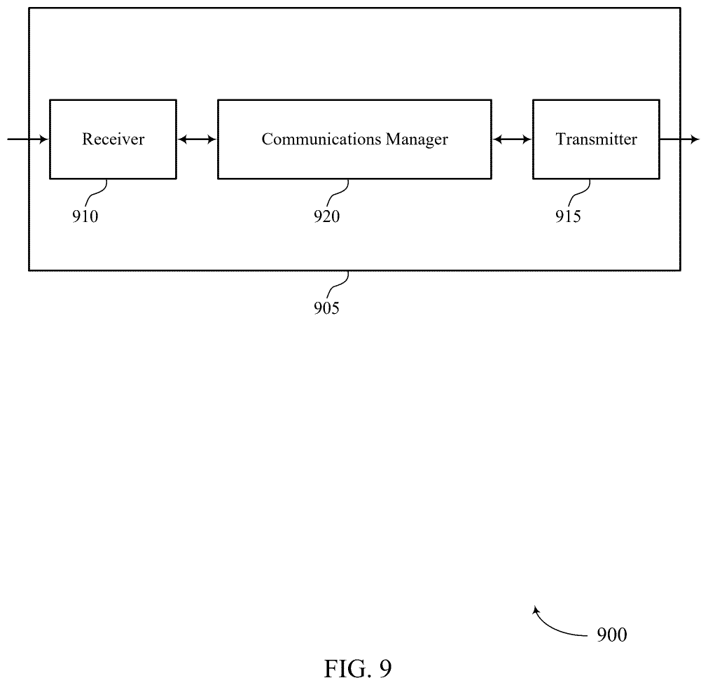

FIG. 9 shows a block diagram 900 of a device 905 that supports techniques for on-demand UE transmissions on secondary cells in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of techniques for on-demand UE transmissions on secondary cells as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting a WUS configuration to a UE that provides a set of multiple WUS occasions for transmission of a WUS associated with a second cell. The communications manager 920 is capable of, configured to, or operable to support a means for outputting, to the UE via a first cell, an indication to transmit the WUS using at least a first WUS occasion of the set of multiple WUS occasions, where the WUS provides information associated with the second cell, and where a first WUS is to be transmitted in the first WUS occasion based on the second signal.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for that allow for efficient network operation through measurement of one or more on-demand WUS transmissions of one or more UEs, while also providing for reduced power consumption by network entities.

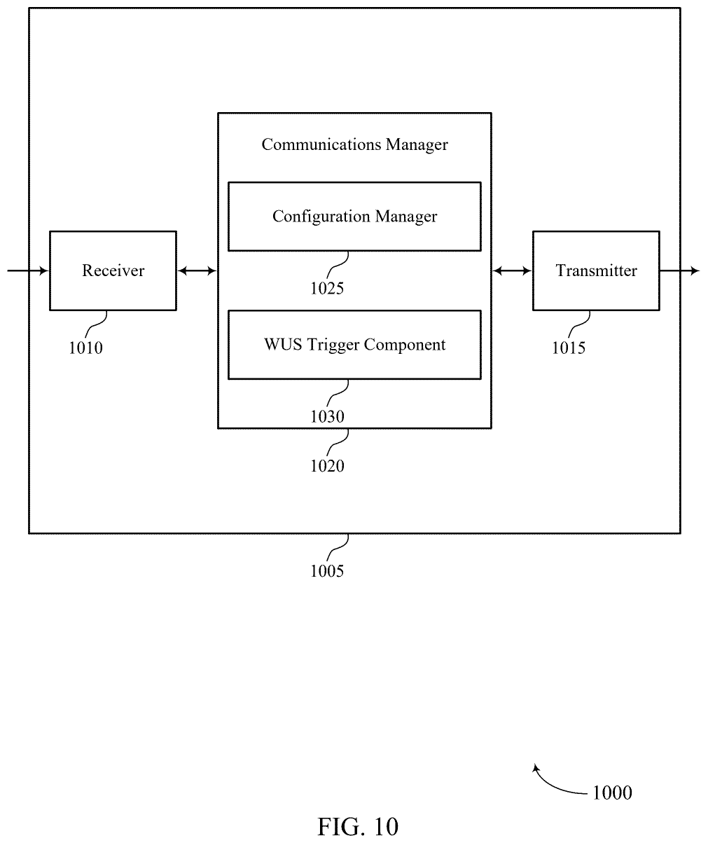

FIG. 10 shows a block diagram 1000 of a device 1005 that supports techniques for on-demand UE transmissions on secondary cells in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one of more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for on-demand UE transmissions on secondary cells as described herein. For example, the communications manager 1020 may include a configuration manager 1025 a WUS trigger component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The configuration manager 1025 is capable of, configured to, or operable to support a means for outputting a WUS configuration to a UE that provides a set of multiple WUS occasions for transmission of a WUS associated with a second cell. The WUS trigger component 1030 is capable of, configured to, or operable to support a means for outputting, to the UE via a first cell, an indication to transmit the WUS using at least a first WUS occasion of the set of multiple WUS occasions, where the WUS provides information associated with the second cell, and where a first WUS is to be transmitted in the first WUS occasion based on the second signal.

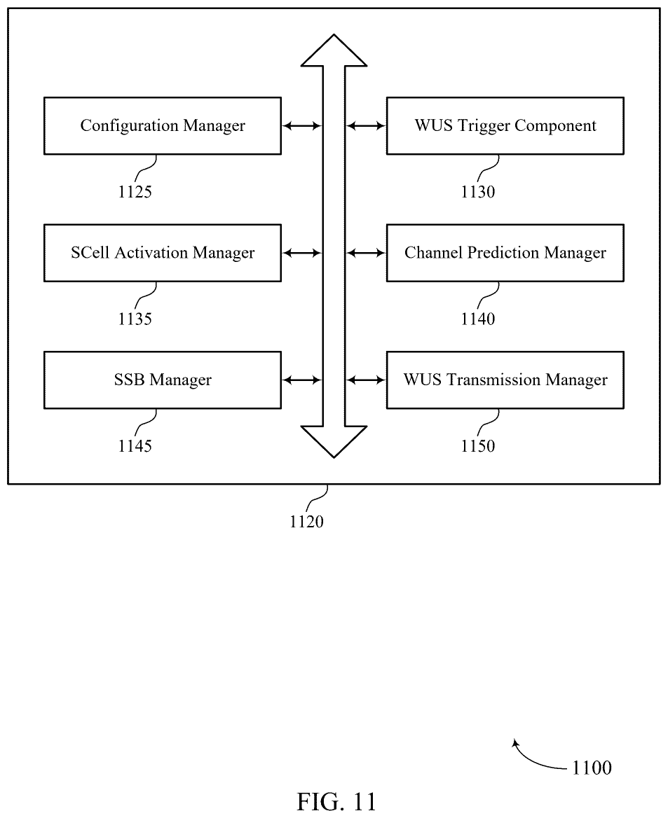

FIG. 11 shows a block diagram 1100 of a communications manager 1120 that supports techniques for on-demand UE transmissions on secondary cells in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for on-demand UE transmissions on secondary cells as described herein. For example, the communications manager 1120 may include a configuration manager 1125, a WUS trigger component 1130, a SCell activation manager 1135, a channel prediction manager 1140, an SSB manager 1145, a WUS transmission manager 1150, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The configuration manager 1125 is capable of, configured to, or operable to support a means for outputting a WUS configuration to a UE that provides a set of multiple WUS occasions for transmission of a WUS associated with a second cell. The WUS trigger component 1130 is capable of, configured to, or operable to support a means for outputting, to the UE via a first cell, an indication to transmit the WUS using at least a first WUS occasion of the set of multiple WUS occasions, where the WUS provides information associated with the second cell, and where a first WUS is to be transmitted in the first WUS occasion based on the second signal.

In some examples, to support outputting the indication to transmit the WUS, the WUS trigger component 1130 is capable of, configured to, or operable to support a means for outputting, to the UE via a first cell, an indication that a set of multiple WUSs are to be transmitted at periodic intervals. In some examples, to support outputting the indication to transmit the WUS, the SCell activation manager 1135 is capable of, configured to, or operable to support a means for outputting an indication that the second cell is to be transitioned from an inactive state to an active state.

In some examples, the indication to transmit the WUS provides an explicit indication or an implicit indication that the WUS is to be transmitted from the UE, and where the second signal is provided in a message that activates the second cell or is provided in a second message that is separate from the message that activates the second cell. In some examples, the indication to transmit the WUS indicates that one or more of the set of multiple WUS occasions are to be used to indicate one or more beams detected at the UE, and where the one or more beams correspond to beams having a highest measurement value, beams having measurement values that exceed a threshold value, or any combination thereof.

In some examples, the indication to transmit the WUS indicates that the WUS is to be transmitted based on a prediction at the UE associated with the first WUS. In some examples, the prediction at the UE is based on a machine learning algorithm output value that satisfies one or more conditions that indicate that the first WUS is to be transmitted.

In some examples, the indication to transmit the WUS indicates whether one or more on-demand SSBs will be activated subsequent to first WUS. In some examples, the indication of whether the one or more on-demand SSBs are activated is indicated dynamically or semi statically for one or more cells.

In some examples, the WUS transmission manager 1150 is capable of, configured to, or operable to support a means for obtaining the first WUS via the first cell. In some examples, the first WUS includes a random access channel transmission, an uplink control channel transmission, or an uplink shared channel transmission. In some examples, the first WUS includes a random access channel transmission having a preamble identification that indicates one or more of a detected secondary cell, one or more detected beams associated with the detected secondary cell, or any combination thereof.

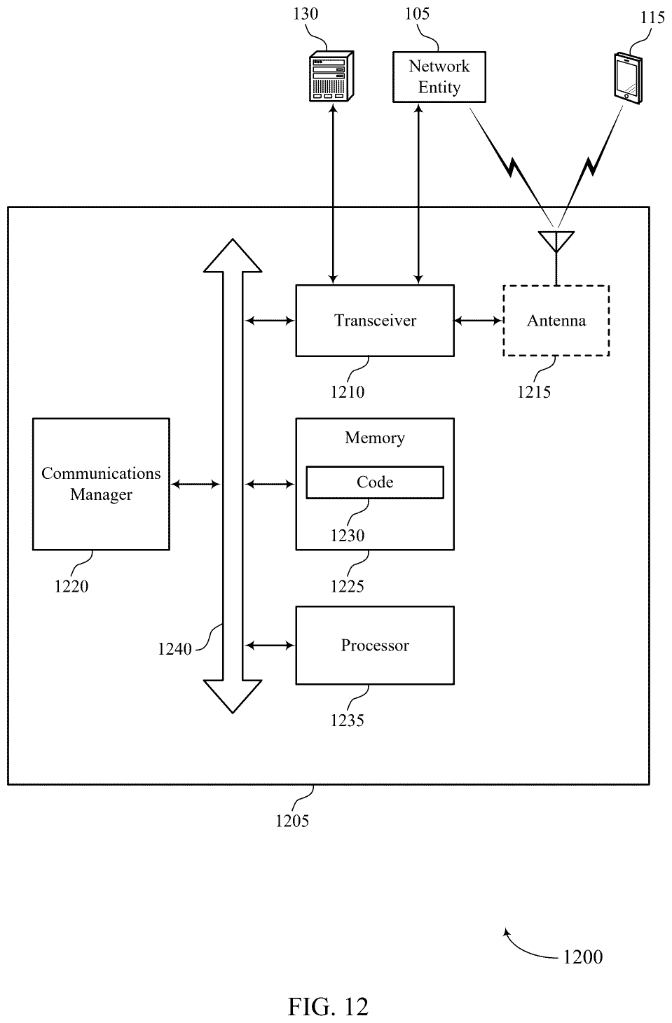

FIG. 12 shows a diagram of a system 1200 including a device 1205 that supports techniques for on-demand UE transmissions on secondary cells in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent

hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for on-demand UE transmissions on secondary cells). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting a WUS configuration to a UE that provides a set of multiple WUS occasions for transmission of a WUS associated with a second cell. The communications manager 1220 is capable of, configured to, or operable to support a means for outputting, to the UE via a first cell, an indication to transmit the WUS using at least a first WUS occasion of the set of multiple WUS occasions, where the WUS provides information associated with the second cell, and where a first WUS is to be transmitted in the first WUS occasion based on the second signal.

By including or configuring the communications manager 1220 in accordance with examples as described herein, the device 1205 may support techniques for signal.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for on-demand UE transmissions on secondary cells as described herein, or the at least one processor 1235 and the at least one memory 1225 may be otherwise configured to, individually or collectively, perform or support such operations.

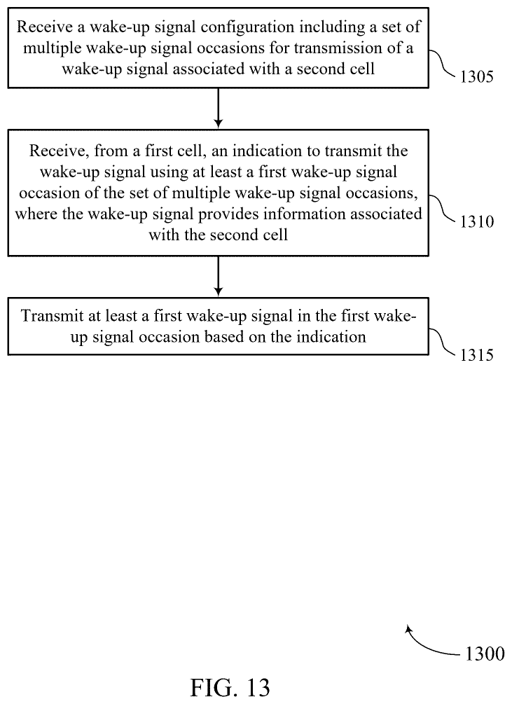

FIG. 13 shows a flowchart illustrating a method 1300 that supports techniques for on-demand UE transmissions on secondary cells in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a WUS configuration including a set of multiple WUS occasions for transmission of a WUS associated with a second cell. The operations of 1305 may be performed in accordance with examples as disclosed herein. In some examples, aspects of the operations of 1305 may be performed by a configuration manager 725 as described with reference to FIG. 7.

At 1310, the method may include receiving, from a first cell, an indication to transmit the WUS using at least a first WUS occasion of the set of multiple WUS occasions, where the WUS provides information associated with the second cell. The operations of 1310 may be performed in accordance with examples as disclosed herein. In some examples, aspects of the operations of 1310 may be performed by a WUS trigger component 730 as described with reference to FIG. 7.

At 1315, the method may include transmitting at least a first WUS in the first WUS occasion based on the indication. The operations of 1315 may be performed in accordance with examples as disclosed herein. In some examples, aspects of the operations of 1315 may be performed by a WUS transmission manager 735 as described with reference to FIG. 7.

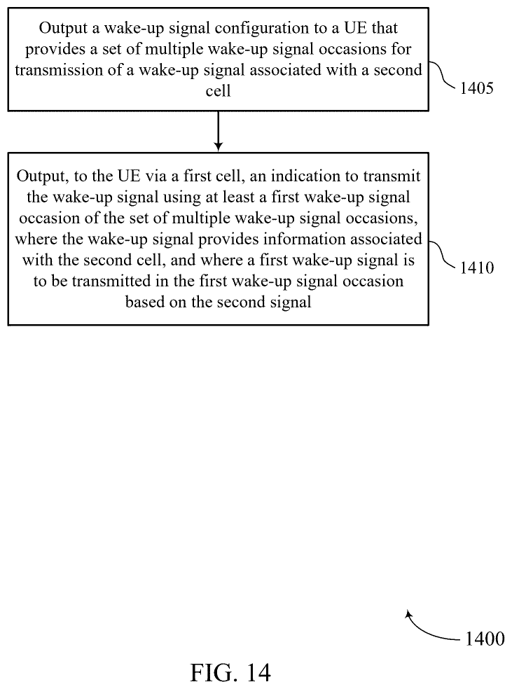

FIG. 14 shows a flowchart illustrating a method 1400 that supports

techniques for on-demand UE transmissions on secondary cells in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include outputting a WUS configuration to a UE that provides a set of multiple WUS occasions for transmission of a WUS associated with a second cell. The operations of 1405 may be performed in accordance with examples as disclosed herein. In some examples, aspects of the operations of 1405 may be performed by a configuration manager 1125 as described with reference to FIG. 11.

At 1410, the method may include outputting, to the UE via a first cell, an indication to transmit the WUS using at least a first WUS occasion of the set of multiple WUS occasions, where the WUS provides information associated with the second cell, and where a first WUS is to be transmitted in the first WUS occasion based on the second signal. The operations of 1410 may be performed in accordance with examples as disclosed herein. In some examples, aspects of the operations of 1410 may be performed by a WUS trigger component 1130 as described with reference to FIG. 11.

The following provides an overview of aspects of the present disclosure:

Aspect 1: A method for wireless communications at a UE, comprising: receiving a WUS configuration including a plurality of WUS occasions for transmission of a WUS associated with a second cell; receiving, from a first cell, an indication to transmit the WUS using at least a first WUS occasion of the plurality of WUS occasions, wherein the WUS provides information associated with the second cell; and transmitting at least a first WUS in the first WUS occasion based at least in part on the indication.

Aspect 2: The method of aspect 1, wherein the receiving the indication to transmit the WUS comprises: receiving an indication that a plurality of WUSs are to be transmitted at periodic intervals, and wherein the transmitting includes transmitting the plurality of WUSs at the periodic intervals.

Aspect 3: The method of any of aspects 1 through 2, wherein the receiving the indication to transmit the WUS comprises: receiving an indication that the second cell is to be transitioned from an inactive state to an active state.

Aspect 4: The method of any of aspects 1 through 3, wherein the indication to transmit the WUS provides an explicit indication or an implicit indication that the WUS is to be transmitted, and wherein the indication to transmit the WUS is provided in a message that activates the second cell or is provided in a second message that is separate from the message that activates the second cell.

Aspect 5: The method of any of aspects 1 through 4, wherein the indication to transmit the WUS indicates that one or more of the plurality of WUS occasions are to be used to indicate one or more beams detected at the UE, and wherein the one or more beams correspond to beams having a highest measurement value, beams having measurement values that exceed a threshold value, or any combination thereof.

Aspect 6: The method of any of aspects 1 through 5, wherein the indication to transmit the WUS indicates that the WUS is to be transmitted based at least in part on a prediction at the UE associated with the first WUS.

Aspect 7: The method of aspect 6, wherein the prediction at the UE is based at least in part on a machine learning algorithm output value that satisfies one or more conditions that indicate that the first WUS is to be transmitted.

Aspect 8: The method of any of aspects 1 through 7, wherein the indication to transmit the WUS indicates whether one or more on-demand SSBs will be activated subsequent to first WUS.

Aspect 9: The method of aspect 8, wherein the indication of whether the one or more on-demand SSBs are activated is indicated dynamically or semi statically for one or more cells.

Aspect 10: The method of any of aspects 1 through 9, wherein transmitting at least the first WUS comprises: transmitting the first WUS to the first cell.

Aspect 11: The method of aspect 10, wherein the first WUS comprises a random access channel transmission, an uplink control channel transmission, or an uplink shared channel transmission.

Aspect 12: The method of any of aspects 10 through 11, wherein the first WUS comprises a random access channel transmission having a preamble identification that indicates one or more of a detected secondary cell, one or more detected beams associated with the detected secondary cell, or any combination thereof.

Aspect 13: A method for wireless communications at a network entity, comprising: outputting a WUS configuration to a UE that provides a plurality of WUS occasions for transmission of a WUS associated with a second cell; and outputting, to the UE via a first cell, an indication to transmit the WUS using at least a first WUS occasion of the plurality of WUS occasions, wherein the WUS provides information associated with the second cell, and wherein a first WUS is to be transmitted in the first WUS occasion based at least in part on the second signal.

Aspect 14: The method of aspect 13, wherein the outputting the indication to transmit the WUS comprises: outputting, to the UE via a first cell, an indication that a plurality of WUSs are to be transmitted at periodic intervals.

Aspect 15: The method of any of aspects 13 through 14, wherein the outputting the indication to transmit the WUS comprises: outputting an indication that the second cell is to be transitioned from an inactive state to an active state.

Aspect 16: The method of any of aspects 13 through 15, wherein the indication to transmit the WUS provides an explicit indication or an implicit indication that the WUS is to be transmitted from the UE, and wherein the second signal is provided in a message that activates the second cell or is provided in a second message that is separate from the message that activates the second cell.

Aspect 17: The method of any of aspects 13 through 16, wherein the indication to transmit the WUS indicates that one or more of the plurality of WUS occasions are to be used to indicate one or more beams detected at the UE, and wherein the one or more beams correspond to beams having a highest measurement value, beams having measurement values that exceed a threshold value, or any combination thereof.

Aspect 18: The method of any of aspects 13 through 17, wherein the indication to transmit the WUS indicates that the WUS is to be transmitted based at least in part on a prediction at the UE associated with the first WUS.

Aspect 19: The method of aspect 18, wherein the prediction at the UE is based at least in part on a machine learning algorithm output value that satisfies one or more conditions that indicate that the first WUS is to be transmitted.

Aspect 20: The method of any of aspects 13 through 19, wherein the indication to transmit the WUS indicates whether one or more on-demand SSBs will be activated subsequent to first WUS.

Aspect 21: The method of aspect 20, wherein the indication of whether the one or more on-demand SSBs are activated is indicated dynamically or semi statically for one or more cells.

Aspect 22: The method of any of aspects 13 through 21, further comprising: obtaining the first WUS via the first cell.

Aspect 23: The method of aspect 22, wherein the first WUS comprises a

random access channel transmission, an uplink control channel transmission, or an uplink shared channel transmission.

Aspect 24: The method of any of aspects 22 through 23, wherein the first WUS comprises a random access channel transmission having a preamble identification that indicates one or more of a detected secondary cell, one or more detected beams associated with the detected secondary cell, or any combination thereof.

Aspect 25: A UE for wireless communications, comprising one or more memories storing processor-executable code, and one or more processors coupled with the one or more memories and individually or collectively operable to execute the code to cause the UE to perform a method of any of aspects 1 through 12.

Aspect 26: A UE for wireless communications, comprising at least one means for performing a method of any of aspects 1 through 12.

Aspect 27: A non-transitory computer-readable medium storing code for wireless communications, the code comprising instructions executable by one or more processors to perform a method of any of aspects 1 through 12.

Aspect 28: A network entity for wireless communications, comprising one or more memories storing processor-executable code, and one or more processors coupled with the one or more memories and individually or collectively operable to execute the code to cause the network entity to perform a method of any of aspects 13 through 24.

Aspect 29: A network entity for wireless communications, comprising at least one means for performing a method of any of aspects 13 through 24.

Aspect 30: A non-transitory computer-readable medium storing code for

wireless communications, the code comprising instructions executable by one or more processors to perform a method of any of aspects 13 through 24.

It should be noted that the methods described herein describe possible

implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a wake-up signal configuration including a plurality of wake-up signal occasions for transmission of a wake-up signal associated with a second cell;
receive, from a first cell, an indication to transmit the wake-up signal using at least a first wake-up signal occasion of the plurality of wake-up signal occasions, wherein the wake-up signal provides information associated with the second cell; and
transmit at least a first wake-up signal in the first wake-up signal occasion based at least in part on the indication.

2. The UE of claim 1, wherein, to receive the indication to transmit the wake-up signal, the one or more processors are individually or collectively operable to execute the code to cause the UE to:
receive an indication that a plurality of wake-up signals are to be transmitted at periodic intervals, and wherein the transmitting includes transmitting the plurality of wake-up signals at the periodic intervals.

3. The UE of claim 1, wherein the indication to transmit the wake-up signal provides an explicit indication or an implicit indication that the wake-up signal is to be transmitted, and wherein the indication to transmit the wake-up signal is provided in a message that activates the second cell or is provided in a second message that is separate from the message that activates the second cell.

4. The UE of claim 1, wherein the indication to transmit the wake-up signal indicates that one or more of the plurality of wake-up signal occasions are to be used to indicate one or more beams detected at the UE, and wherein the one or more beams correspond to beams having a highest measurement value, beams having measurement values that exceed a threshold value, or any combination thereof.

5. The UE of claim 1, wherein the indication to transmit the wake-up signal indicates that the wake-up signal is to be transmitted based at least in part on a prediction at the UE associated with the first wake-up signal.

6. The UE of claim 5, wherein the prediction at the UE is based at least in part on a machine learning algorithm output value that satisfies one or more conditions that indicate that the first wake-up signal is to be transmitted.

7. The UE of claim 1, wherein the indication to transmit the wake-up signal indicates whether one or more on-demand synchronization signal blocks (SSBs) will be activated subsequent to first wake-up signal.

8. The UE of claim 7, wherein:
the indication of whether the one or more on-demand SSBs are activated is indicated dynamically or semi statically for one or more cells.

9. The UE of claim 1, wherein, to transmit at least the first wake-up signal, the one or more processors are individually or collectively operable to execute the code to cause the UE to:
transmit the first wake-up signal to the first cell.

10. The UE of claim 9, wherein the first wake-up signal comprises a random access channel transmission, an uplink control channel transmission, or an uplink shared channel transmission.

11. The UE of claim 9, wherein the first wake-up signal comprises a random access channel transmission having a preamble identification that indicates one or more of a detected secondary cell, one or more detected beams associated with the detected secondary cell, or any combination thereof.

12. A network entity, comprising:
one or more memories storing processor-executable code; and
one or more processors coupled with the one or more memories and individually or collectively operable to execute the code to cause the network entity to:
output a wake-up signal configuration to a user equipment (UE) that provides a plurality of wake-up signal occasions for transmission of a wake-up signal associated with a second cell; and
output, to the UE via a first cell, an indication to transmit the wake-up signal using at least a first wake-up signal occasion of the plurality of wake-up signal occasions, wherein the wake-up signal provides information associated with the second cell, and wherein a first wake-up signal is to be transmitted in the first wake-up signal occasion based at least in part on the second signal.

13. The network entity of claim 12, wherein, to output the indication to transmit the wake-up signal, the one or more processors are individually or collectively operable to execute the code to cause the network entity to:
output, to the UE via a first cell, an indication that a plurality of wake-up signals are to be transmitted at periodic intervals.

14. The network entity of claim 12, wherein, to output the indication to transmit the wake-up signal, the one or more processors are individually or collectively operable to execute the code to cause the network entity to:
output an indication that the second cell is to be transitioned from an inactive state to an active state.

15. The network entity of claim 12, wherein the indication to transmit the wake-up signal indicates that the wake-up signal is to be transmitted based at least in part on a prediction at the UE associated with the first wake-up signal.

16. The network entity of claim 15, wherein the prediction at the UE is based at least in part on a machine learning algorithm output value that satisfies one or more conditions that indicate that the first wake-up signal is to be transmitted.

17. The network entity of claim 12, wherein the indication to transmit the wake-up signal indicates whether one or more on-demand synchronization signal blocks (SSBs) will be activated subsequent to first wake-up signal.

18. The network entity of claim 12, wherein the one or more processors are individually or collectively further operable to execute the code to cause the network entity to:
obtain the first wake-up signal via the first cell.

19. A method for wireless communications at a user equipment (UE), comprising:
receiving a wake-up signal configuration including a plurality of wake-up signal occasions for transmission of a wake-up signal associated with a second cell;
receiving, from a first cell, an indication to transmit the wake-up signal using at least a first wake-up signal occasion of the plurality of wake-up signal occasions, wherein the wake-up signal provides information associated with the second cell; and
transmitting at least a first wake-up signal in the first wake-up signal occasion based at least in part on the indication.

20. The method of claim 19, wherein the receiving the indication to transmit the wake-up signal comprises:
receiving an indication that a plurality of wake-up signals are to be transmitted at periodic intervals, and wherein the transmitting includes transmitting the plurality of wake-up signals at the periodic intervals.
